(19) United States
(12) Patent Application Publication
(10) Pub. No.: US 2010/0124189 A1
(43) Pub. Date: May 20, 2010

(54) METHOD FOR TRANSMITTING DATA PACKETS AND CONRREPONDING RECEPTION METHOD

(76) Inventors: Charline Guguen, Bourgbarre (FR); Patrick Fontaine, Rennes (FR); Ludovic Jeanne, Rennes (FR)

Correspondence Address: Robert D. Shedd, Patent Operations;THOMSON Licensing LLC, P.O. Box 5312, Princeton, NJ, 08543-5312, US

(21) Appl. No.: 12/451,518

(22) PCT Filed: May 26, 2008
(86) PCT No.: PCT/EP2008/056425

§ 371 Date: Nov. 16, 2009

(30) Foreign Application Priority Data
May 24, 2007 (FR) 0755252

(51) Int. Cl. H04W 40/00

(52) U.S. Cl. 370/328

(57) ABSTRACT

In order to guarantee a quality of service, the method, implemented in a first station, each first packet being transmitted by said first station intended for at least two second stations, the said second stations belonging to a set comprising several second stations, comprises:
a reception of at least one acknowledgement of each first packet received correctly by at least one second station, said acknowledgement or acknowledgements being transmitted by the second station or stations having correctly received said first packet,
a retransmission of each first packet not acknowledged at least once.

### 1. FIELD OF THE INVENTION

The present invention relates to the wireless telecommunications field and more precisely the transmission of data, reliable by a base station via two subscriber stations (or remote stations).

### 2. TECHNOLOGICAL BACKGROUND

According to the prior art, several wireless network architectures are known. Some of them are based on a centralised architecture. Hence, the Wi-Fi system (based on the IEEE 802.11a standard) has a non-centralised task sequencing architecture (or scheduling) with a contention channel access. Such an architecture does not enable a sufficient Quality of Service (or QoS) to be managed effectively for some applications. The Wimax system (based on the IEEE 802.16 standard) possesses a centralised scheduling architecture which allows the implementation of a more appropriate quality of service for certain applications (maximum delivery time for a packet (typically 5 ms) and bandwidth guaranteed for each connection request).

Nevertheless, the techniques implemented in the Wimax networks do not enable a quality of service to be guaranteed for all the applications, for example for video type communications, data being transmitted by wireless cameras moving around in noisy radio-frequency environments, subject to interference or disturbed by obstacles creating signal losses or echoes. Hence, a communication with a wireless station can be cut off suddenly (for example, when the mobile station is moving around). Indeed, the support or the coverage of a wireless link cannot be guaranteed, which may cause transmission problems when a station or its environment moves.

The mobile networks such as those described in the patent document US 2006/0154603 entitled “Method and devices for efficient data transmission link control in mobile multicast communication systems” provide the systems with packet retransmissions as long as all the packets are not correctly acknowledged by all the receivers. However, the method described in this document is not optimised for the use of resources with a quality of service guarantee.

### 3. SUMMARY OF THE INVENTION

The purpose of the invention is to overcome the disadvantages of the prior art.

More particularly, the purpose of the invention is to enable the transmission and/or reception of data by at least one wireless station intended for relay stations, with a guaranteed quality of service and more specifically with an absence of cutting off of the communication (namely, with no loss of packets having to be received by the wireless station or stations) under normal conditions of use.

The invention concerns a transmission method of first data packets, the method being implemented in a first station, each first packet being transmitted by the first station intended for at least two second stations, the second stations belonging to a set comprising several second stations. In order to guarantee a quality of service, the method comprises:
a reception of at least one acknowledgement of each first packet received correctly by at least one second station, said acknowledgement or acknowledgements being transmitted by the second station or stations having correctly received the first packet;
a retransmission of each first packet not acknowledged at least once, each first packet acknowledged at least once not being retransmitted.

Advantageously, the method comprises:
A cut of a second data packet (SDU) in one or more first data packets (PDU);
a retransmission of each first packet not acknowledged at least once belonging to a second packet of which at least one first packet has not been acknowledged at least once, the first packets not being retransmitted when they belong to a second packet of which all the first packets have been acknowledged at least once.

Here, first packets or Packet data units or PDU corresponds to a current layer and second packets or service data units or SDU corresponds to packets that are in a layer over the current layer.

Advantageously, the method comprises:

a split of a second data packet (SDU) in one or more first data packets (PDU);
a retransmission of each first packet not acknowledged at least once belonging to a second packet of which at least one first packet has not been acknowledged at least once, the first packets not being retransmitted when they belong to a second packet of which all the first packets have been acknowledged at least once by at least one second station, and advantageously by at least a same second station.

According to a particular characteristic, it comprises a discard request of at least one first packet to a second station when all the first packets of the second packet have been acknowledged at least once by at least one second station, and advantageously at least as same second station.

According to a particular characteristic, the packet or packets are in the medium access control communication layer called MAC layer.

Advantageously, the packet or packets are transmitted on a wireless channel, for example of the IEEE 802.16 type. According to a specific feature, connections between the first station and second stations are established according to a IEEE 802.16 protocol.

According to a specific feature, the method comprises the following steps:
reception of data packets by first station, the data packets being built by second stations from a given service data unit packet and having a similar structure and the same numbering; and
transmission of an acknowledgement to each second station indicating that the first station has correctly received at least a data packet from at least a second station.

The invention also relates to a reception method of first data packets, the method being implemented in at least two second stations, each first packet being transmitted by first station intended for said at least two second stations. In order to have a good quality of services, the method comprises:
a reception of at least a first data packets by at least one second station;
   a transmission of at least one acknowledgement of each first packet received correctly by at least one second station, said acknowledgement or acknowledgements being transmitted to first station by the second station or stations having correctly received first packet from the first station,
   a construction of a second data packet (SDU) from one or more first data packets (PDU), if all corresponding first data packets have been correctly received, and a sending of second data packet to a destination; and
   a discard of at least one first packet upon a reception of a corresponding discard request (814, 840) from the first station.

Thus, when a second station receives a discard request, it discards the corresponding packet or packets, even if the first station has not received the corresponding packet or packets from this second station and has received the corresponding packet or packets from another second station.

### 4. LIST OF FIGURES

The invention will be better understood, and other specific features and advantages will emerge from reading the following description, the description making reference to the annexed drawings wherein:

FIG. 1 illustrates an example of a communication network architecture with elements implementing the invention,

FIGS. 2 and 3 diagrammatically show, respectively, a mobile wireless station and a relay station belonging to the network of FIG. 1, according to a particular embodiment of the invention,

FIGS. 4 and 5 show an implementation method in the wireless station of FIG. 2, according to the particular embodiments of the invention;

FIGS. 6 and 7 show an implementation method in the relay station of FIG. 3, according to the particular embodiments of the invention;

FIG. 8 illustrates an example of communication between different network elements of FIG. 1, and

FIG. 9 gives an example of frame exchanged by the network elements of FIG. 1.

### 5. DETAILED DESCRIPTION OF THE INVENTION

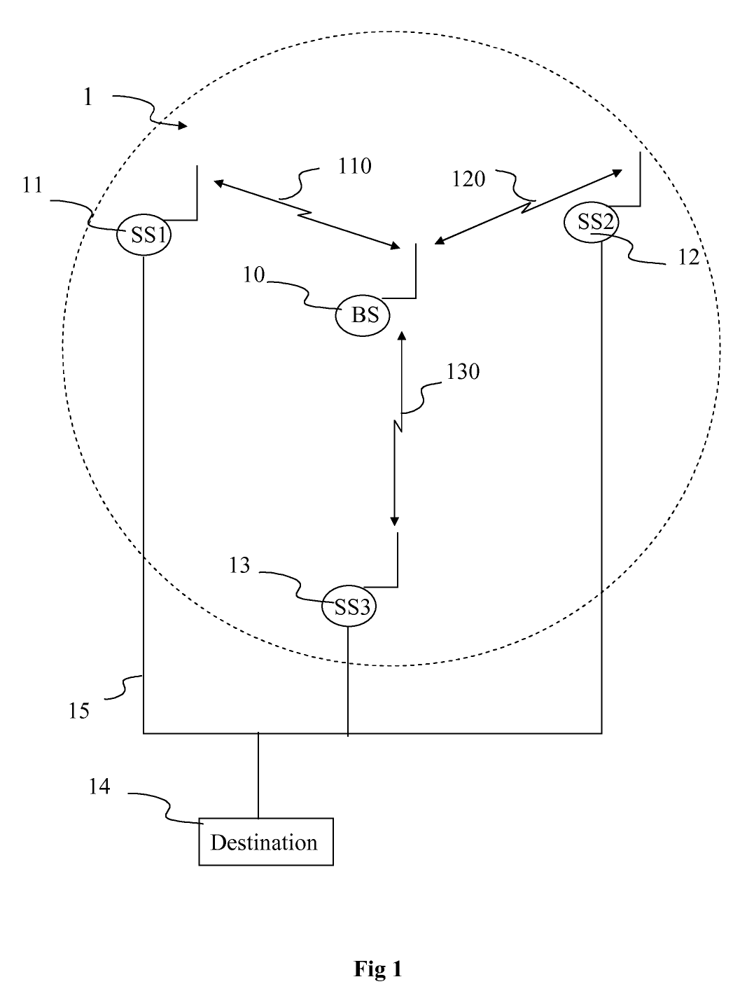

FIG. 1 shows a communication network comprising a wireless network 1 and a wired Ethernet network (or IEEE 802.3).

The wireless network 1 comprises one or more wireless stations, fixed or, advantageously mobile. A wireless station is for example a base station (or BS) BS 10. If there are several base stations, they use different physical channels (for example, frequency channels or CDMA “Code Multiple Division Access” or “Multiple access by code division”, temporal allocations (TDMA “Time Division Multiple Access” or “Multiple access by time division”).

The Ethernet network comprises a destination 14 node.

Base station 10 can transmit or receive data (for example images) intended for or (for example control data) coming from node 14 via the relay stations (RS) or subscriber stations (SS) SS1 11, SS2 12 and SS3 13 (second wireless network stations). The subscriber stations 11 to 13 allow the interface between the wireless network 1 and the Ethernet network to be provided. Hence, the subscriber station 11 (12, 13 respectively) is connected via a bidirectional wireless link 110 (120, 130 respectively) to the base station 10. The network architecture 1 is such that the network 1 comprises enough subscriber stations to cover the entire zone in which the base stations are likely to be found. Hence, at any time, each mobile station of the network 1 is connected to at least one base station of the network 1 by a wireless link enabling a wireless communication to be provided. The subscriber stations 11 to 13 are connected directly or via a hub by an Ethernet 15 link (or any other network enabling the transmission and the reception of data) to the node 14. According to an embodiment variation, they are also connected to each other via an Ethernet link (or any other type of wired or wireless link). Hence, for example, if the base station 10 is connected to the subscriber station SS1 11, it can transmit data to the node 14 via the links 110 and 15. Advantageously, the destination is capable of retransmitting the stream on another wired or wireless interface to another item of equipment.

The base station or stations are for example mobile cameras, equipped with wireless communication means and the node 14 is an image processing system (for example, a video recorder, a studio entry point etc.). Hence, the FIG. 1 network enables a continued (i.e. without interruption) data transmission (for example images) to a processing system by cameras located on the interior or the exterior of buildings for retransmitting any event (for example a sporting event or a show) on an equally nondescript geographic zone.

Advantageously, the subscriber stations share the same radio frequency channel, the radio spectrum being a resource to be economised. The subscriber stations can possibly listen mutually to each other on the radio channel. According to an embodiment variation, the subscriber stations cannot listen mutually to each other on the radio channel.

Advantageously, the communications used between the nodes of the network of FIG. 1 are of the IP type (Internet Protocol), the SS, the BS and the node 14 each having an IP address. IP is used to transport the flow in streaming mode, for example for transporting video and/or audio in unidirectional or bidirectional mode.

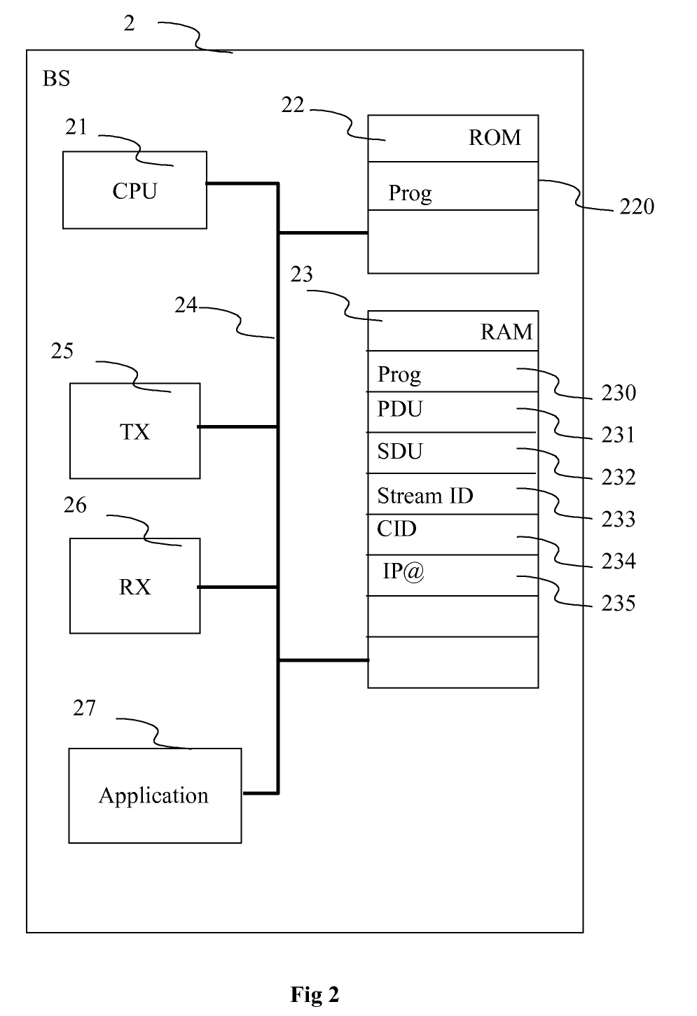

FIG. 2 diagrammatically illustrates a mobile station 2 of the network 1 corresponding to the base station 10.

The mobile station 2 comprises, connected to each other by a bus 24 addresses and data, also transporting a clock signal:
a microprocessor 21 (or CPU);
a non-volatile memory of the ROM (Read Only Memory) type 22;
a Random Access Memory or RAM 23;
a transmission module 25 of a signal on the wireless link;
a reception module 26 of a signal on the wireless link; and
an interface 27 to an application (for example the capture of images and/or sound).

It is noted that the word “register” used in the description of memories 22 and 23 designates in each of the memories mentioned, a memory zone of low capacity (some binary data) as well as a memory zone of large capacity (enabling a whole programme to be stored or all or part of the data representing an audio/video service received).

The application is, for example, of the video type and constitutes respectively the source and destination of the data respectively transmitted and received by the mobile station 2 (the mobile station 2 is for example a camera or a radio system associated with the camera).

The ROM memory 22 notably comprises a programme “prog” 220.

The algorithms implementing the steps of the method specific to the invention and described below are stored in the ROM 22 memory associated with the mobile station 2 implementing these steps. When powered up, the microprocessor 21 loads and runs the instructions of these algorithms.

The random access memory 23 notably comprises:
in a register 230, the operating programme of the microprocessor 21 responsible for switching on the mobile station 2;
The data or the PDU (“Packet Data Unit”) corresponding to the data packets of level 2 or MAC (“Medium Access Control”) containing this data in a register 231;
data packets of type SDU (“Service Data Unit”) being able to contain several PDU in a register 232;
an SID (“Stream ID”) flux identifier in a register 233, the SID identifier enabling the classification to be made (“classifying” function according to the IEEE 802.16 standard);
One or more connection identifiers or CID in a register 234; and
an IP address of the mobile station 2 in a register 235.

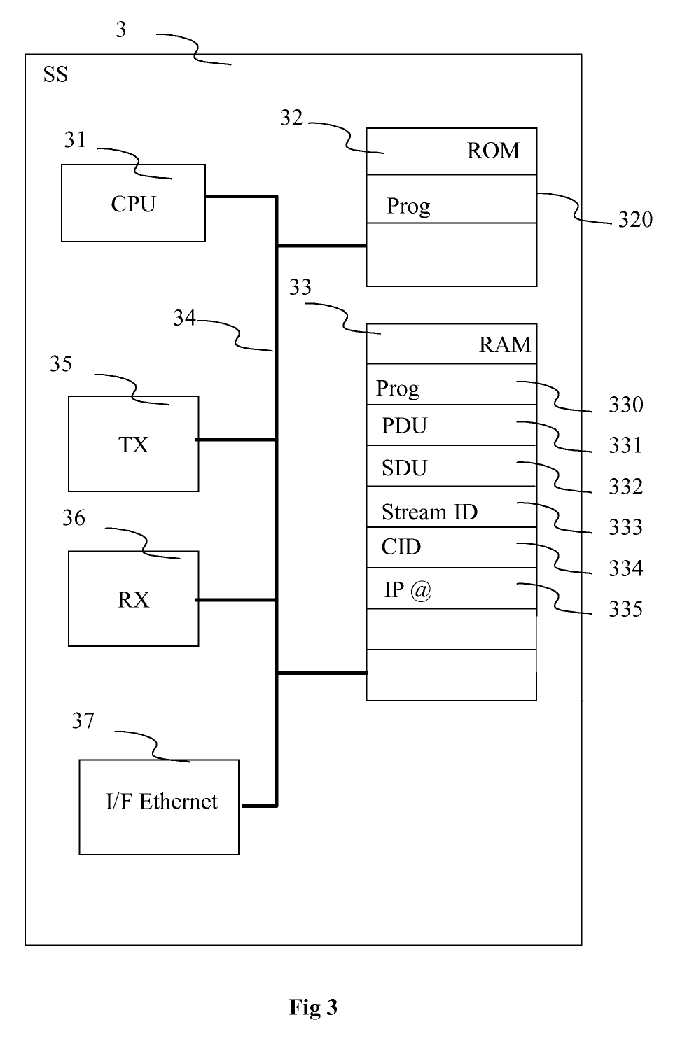

FIG. 3 diagrammatically illustrates a subscriber station 3 of the network 1 corresponding to SS1, SS2 or SS3.

The subscriber station 3 comprises, connected to each other by an address and data bus 34, also transporting a clock signal:
a microprocessor 31 (or CPU);
a non-volatile memory of the ROM (Read Only Memory) type 32;
a Random Access Memory or RAM 33;
a transmission module 35 of a signal on the wireless link;
a reception module 36 of a signal on the wireless link; and
an interface 37 to an Ethernet network.

It is noted that the word “register” used in the description of memories 32 and 33 designates in each of the memories mentioned, a memory zone of low capacity (some binary data) as well as a memory zone of large capacity (enabling a whole programme to be stored or all or part of the data representing an audio/video service received).

The ROM memory 32 notably comprises a programme “prog” 320.

The algorithms implementing the steps of the method specific to the invention and described below are stored in the ROM 32 memory associated with the subscriber station 3 implementing these steps. When powered up, the microprocessor 31 loads and runs the instructions of these algorithms.

The random access memory 33 notably comprises:
in a register 330, the operating programme of the microprocessor 31 responsible for switching on the subscriber station 3;
data or PDUs containing this data in a register 331;
data packets of type SDU (“Service Data Unit”) being able to contain several PDU in one register 332;
one flux identifier in a register 333;
one or more connection identifiers or CID in a register 334, and
an IP address of the mobile station 2 in a register 335.

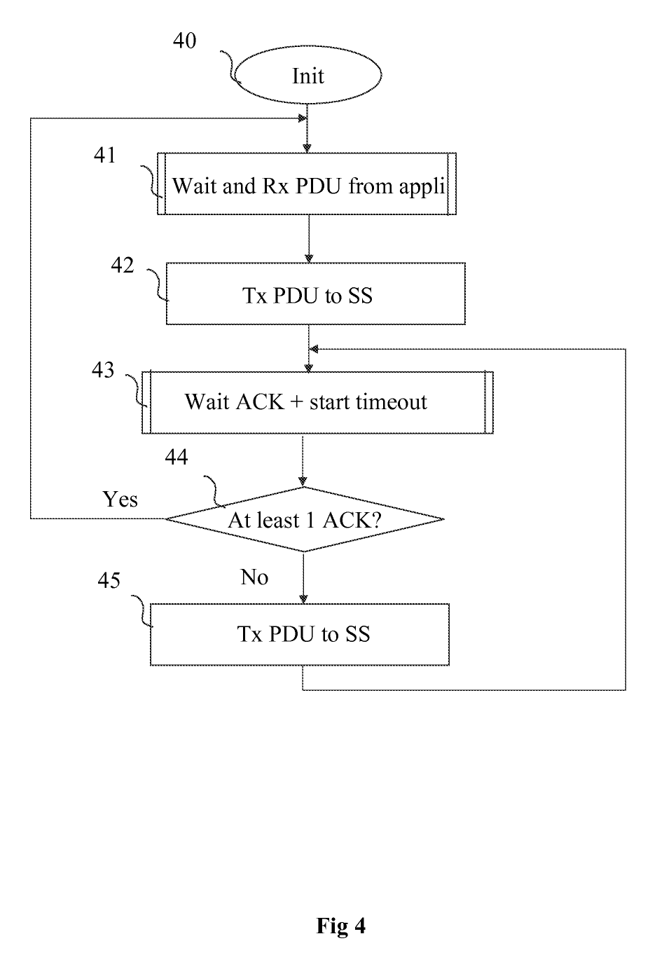

FIG. 4 shows a method used in the wireless station 2 according to a particular implementation of the invention.

This method begins with an initialisation phase 40 during which the different parameters of the station 2 are updated.

Then, during a step 41, the station 2 waits then receives at least one PDU from one application.

Then, during a step 42, the station 2 numbers each PDU and transmits them in one or more bursts to the SS 11 to 13.

Then, during a step 43, the station 2 waits for the acknowledgements during a time limited by a timeout. The value of the timeout is for example comprised between 2 and 10 ms.

Then, during a test 44, the station 2 verifies whether a positive acknowledgement (ACK) has been received for each PDU packet transmitted. In the affirmative case, the step 41 is repeated.

If for at least one packet transmitted, no positive acknowledgement has been received (no acknowledgement has been received or only negative acknowledgements or NACK have been received), then, during a step 45, the packets not positively acknowledged are transmitted again to the SS 11 to 13, each first packet acknowledged at least once not being retransmitted. The step 43 is then repeated.

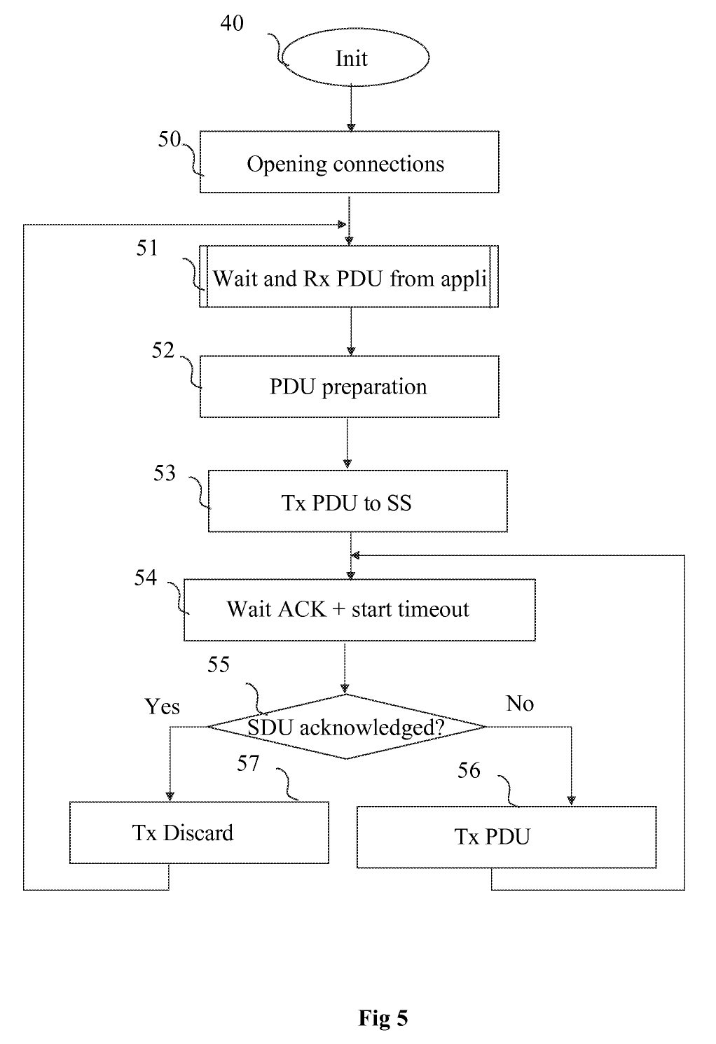

FIG. 5 shows a method used in the station 2 according to a particularly advantageous implementation of the invention, in the context of a wireless network comprising notably subscriber stations 11 to 13 compatible with the IEEE 802.16 standard. The common steps with the method illustrated in FIG. 4 have the same references and are not described in further detail.

After an initialisation step 40, during a step 50, a connection is open with the SSs with the advantageously identical parameters (bit-rate, latency, etc.). Advantageously, the same CID is associated with each downward connection between the SS and the BS. Hence, each SS functions according to the IEEE 802.16 standard. The BS transmits on the downward connection to all the stations following a same burst of the multicast type, or, according to a variant, a PDU is transmitted in several bursts, each burst being associated with a single SS. For the upward direction, each SS transmits the acknowledgements in the associated burst. The BS thus identifies the SS which transmitted an acknowledgement. According to a variant, the acknowledgement comprises an SS identifier (for example, a specific CID used for the acknowledgement transmission in the upward direction between the SS and the BS) which is used by the BS to identify the SS having transmitted the acknowledgement.

Then, during a step 51, the station 2 waits then receives at least one SDU from the application 27 and intended for the node 14.

Then during a preparation step of PDU 52, the station 2 cuts out the SDU received in PDUs, memorises the PDUs and numbers them to identify them. An “untransmitted” status type is associated with each PDU.

Then, during a step 53, the station 2 transmits the PDUs in one or more bursts to each of the SS according to a IEEE 802.16 type communication protocol. The status associated with each PDU is updated by becoming the “transmitted” type.

Then, during a step 54, the station 2 waits for a cumulative and/or selective acknowledgement from the SSs recipients of the PDUs. This acknowledgement may be positive (ACK) or negative (NACK). An acknowledgement comprises a CID connection identifier used for the transmission of PDUs in the downward direction, an acknowledged PDU number (cumulative or selective ACK) or several acknowledged PDUs (cumulative selective ACK). The BS identifies the SS having transmitted the acknowledgement, for example, by the time slot used by the SS and/or by a specific field contained in the acknowledgement.

According to a variant of the invention, independently or in connection with reception of PDU transmitted by the BS, SSs are receiving SDU from the Ethernet network (e.g. from node 14) and transmit corresponding PDU to the BS, the building of PDU being the same for each SS (i.e. when a SDU is received by SS, then, the slicing of SDU into PDU made by each SS is the same). The numbering of the PDUs in the BS is also identical and unique for PDUs transmitted by all the SSs. The ACK received by the SSs correspond to the identical data in the BS. Then, according to this variant, each SSs receiving a positive ACK for a PDU discards it, even if this PDU transmitted by the given SS has not being received correctly by the BS, a corresponding (i.e. with same content and numbering) PDU transmitted by another SS being received correctly by the BS and acknowledged.

According to an advantageous variant, the station 2 launches a timeout during the transmission step and the flow of this timeout corresponds to the reception of a NACK.

Then, during a test 55, the station 2 checks whether all the PDUs of the SDU or SDUs received are acknowledged by at least one SS (PDUs of a given SDU being acknowledged by one SS or different SSs) or, according to a variant, by at least one same SS (one SS or several SSs having acknowledged all the PDUs from a given SDU).

For each SDU received of which all the PDU are acknowledged by at least one SS, (a specific SS having sent the acknowledgment for all the PDU of the received SDU or, according to a variant, a specific SS or different SSs having sent the acknowledgment for all the PDU of the received SDU), during a step 57, the station 2 transmits a discard type message to each SS having not acknowledged at least one PDU from the SDU considered. This message enables each SS to erase from its memory the PDUs from the SDU considered by supposing that they are received correctly, without sending them to the destination 14 node. Hence, the PDU are not retransmitted when they belong to a SDU of which all the PDU have been acknowledged at least once. It also enables that the PDUs from the considered and not received SDU are no longer awaited. The station 2 waits for a positive acknowledgement in response to the “discard” message and sends back the “discard” message as long as it is not acknowledged. According to a variant, after a determined number of acknowledgement absences from an SS, the BS considers the SS as desynchronised and will send it a resynchronisation order once the link with the SS is re-established with an adequate quality. This enables the corresponding SS to receive the PDUs again by having an ARQ reception window synchronised with the ARQ transmission window associated with the BS. The step 51 is then repeated.

If the test 55 result is negative, during a step 56, the PDUs which are not part of the acknowledged SDU are retransmitted by the BS.

According to the variant of the test 55, the BS considers that a SDU can be reconstructed as soon as all the PDU of the SDU have been received by at least one SS (and not necessarily by the same SS). In this case, the step 56 is also adapted so as to only transmit the PDU which have not been received by at least one SS. This variant can be implemented, for example, if the destination node, an intermediate node or one of the SS reconstructs the SDU from the PDU which can be received by the separate SS. According to a specific embodiment of this variant, SSs can forward to other SSs PDUs that are not received correctly by other SSs or to a specific SS, so that at least one SS can built a corresponding SDU, even if it has not received the PDUs of the SDU through the wireless network.

According to a variant implementing exchanges between the SS via any channel (for example, via the wired network 15), each SS transmits the acknowledged (positive) or not acknowledged status of the PDUs received previously and possibly the acknowledged status of a SDU to the other SS. The step 57 can then be deleted; each SS can then erase the PDUs corresponding to the acknowledged SDU from the memory.

The transmission of PDU acknowledgements by the SSs is advantageously done in a cumulative form.

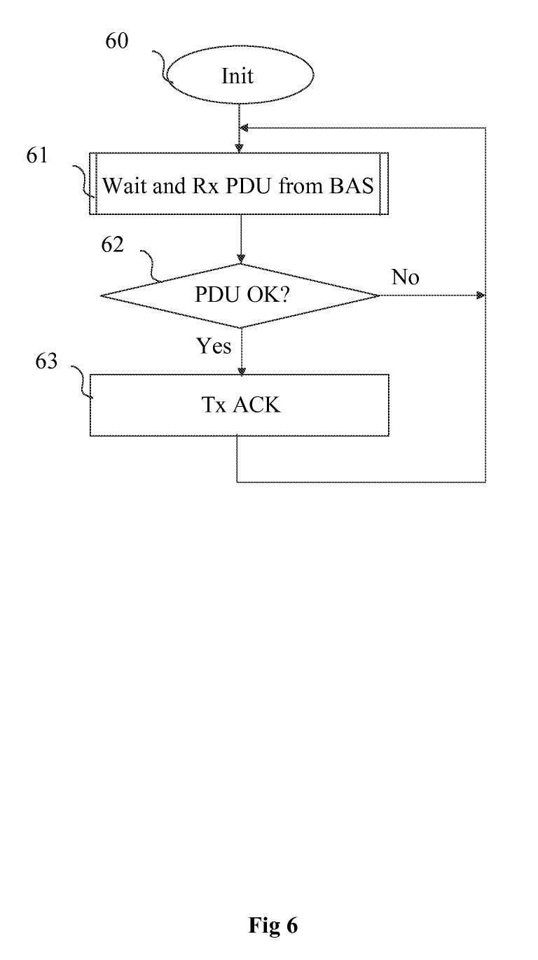

FIG. 6 shows a method used in the subscriber station 3 according to a particular implementation of the invention.

This method begins with an initialisation phase 60 during which the different parameters of the station 3 are updated.

Then, during a step 61, the station 3 waits then receives at least one PDU from the base station 10, the base station transmitting a PDU with the same useful data to several SS.

Then, during a step 62, the station 3 checks that the PDU transmitted by the base station 10 is received correctly (for example, by checking an error detection code present in the received PDU).

In the negative, the step 61 is repeated.

In the positive, during a step 63, the station 3 transmits a positive acknowledgement or ACK of level 2 (MAC layer) indicating a correctly received PDU, at the base station 3. The corresponding PDU is transmitted to the application and the step 61 is repeated. If a same PDU is transmitted several times to the station 3 while being received correctly, the station 3 discards the duplicates.

If for a given PDU, the station 2 does not correctly receive the corresponding PDU transmitted by the subscriber stations and if the station 2 identifies the number (for example, if a PDU with a more recent number is received correctly), according to a variant of the step 63, the station 2 transmits a negative acknowledgement or NACK identifying the incorrectly received PDU, to the base station 10.

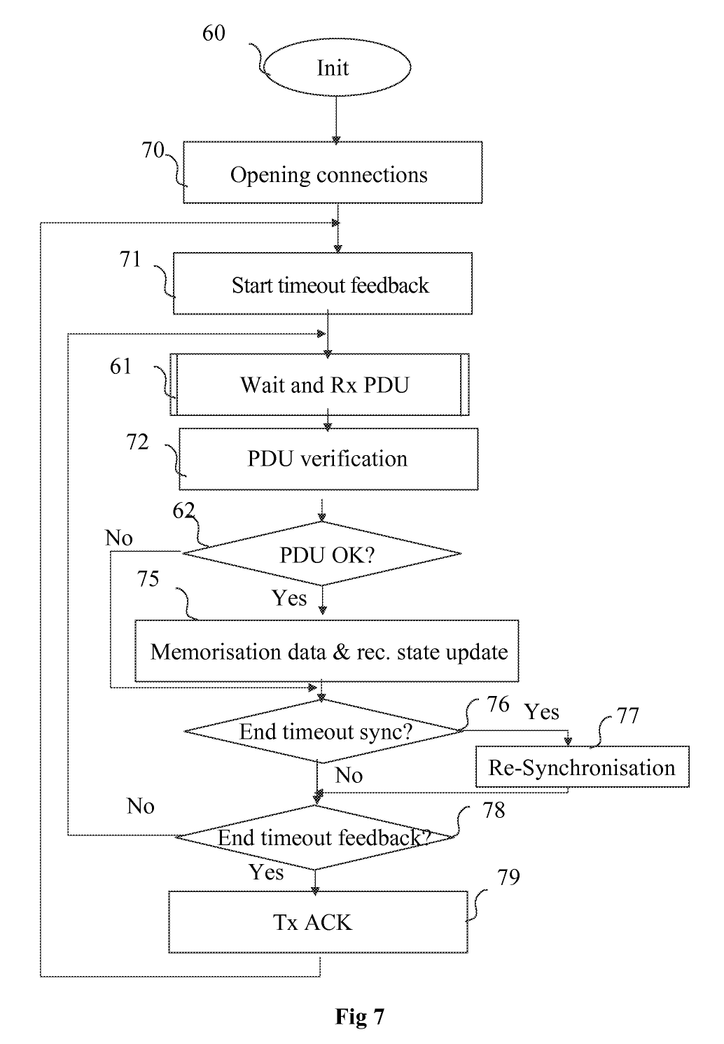

FIG. 7 shows a method implemented in the station 3 according to a particularly advantageous implementation of the invention, within the context of a wireless link between the BS and the station 3, compatible with the IEEE 802.16 standard. The common steps with the method illustrated in FIG. 6 have the same references and are not described in further detail.

After an initialisation step 40, during a step 70, the station 3 opens a connection associated with the base station. Advantageously, the BS creates a connection in the downward direction which is identical for all the SS. The connection is associated with the same parameters (for example the bit-rate, the latency, ARQ parameters and classification parameters (SID)) and with the same CID identifier (“Connection Identifier”). This allows a simpler operation and a bandwidth saving on the network connecting the BS to the SS.

According to a variant, the station 2 controls the connections associated with several flows, these flows being able to correspond to the different data types and/or the separate sources. Each of the flows is identified by a SID which is specific to it and transmitted on specific connections (two connections on two separate flows are differentiated).

Then, during a step 71, a feedback timeout is launched.

Then, PDU reception steps 61, a correctly received PDU verification test 72 associated with a test step 62 are carried out.

If this is the case, the PDU or PDUs being correctly received, during a step 75, each correctly received PDU comprising the data is memorised and the corresponding PDU status in the PDU descriptor is updated (the status switches from “not received” to “received”). If the PDU is of the “discard” type, the station 3 updates the corresponding PDU statuses by indicating a “received” status. If the “discard” is selective, the acknowledgement is advantageously selective. If the “discard” is cumulative, the acknowledgement is advantageously cumulative. According to a variant, when a “discount” type PDU is received, the station 3 forces the end of the “feedback” timeout. If the same PDU is received several times in the correct manner, the duplicates are discarded. Advantageously, the PDU are transmitted to the recipient node after reconstruction of an entire SDU comprising the corresponding PDU. According to a variant of the invention, an SDU can be constructed with the PDUs from the different SSs, for example, by the recipient node or an intermediate node and advantageously by an SS. The SS then transmits the correctly received PDUs of the BS, in the entity which reconstructs the SDU or keeps them for itself if it reconstructs the SDU itself from the PDUs that it receives from the BS or from other SS.

According to a particular embodiment, synchronisation timeouts are implemented for each connection and for each connection, an ARQ reception window which defines the first incorrectly received PDU. For a given connection, if the first incorrectly received PDU changes, then the synchronisation timeout associated with this connection is reset.

Following a negative result of the test 62 (timeout limit value reached or incorrectly received PDU detected) or of the step 75, during a test 76, the station 3 checks that a synchronisation timeout has reached a determined value limit (for example 100 ms) for each connection.

If this is the case (timeout limit value reached), during a step 77, the synchronisation is lost and the station 3 waits for a resynchronisation order with the current PDU number from the BS.

According to a variant, the station 32 does not implement the synchronisation timeouts and therefore the test 76 and the step 77.

Following a negative result of the test 76 (synchronisation timeout limit value not reached) or of the step 77, during a test 78, the CPU 31 checks whether the feedback timeout launched in the step 71 is passed. The maximum value is for example between 2 and 10 ms. In the negative, the step 72 is repeated.

If the result of the test 78 is positive, the timeout is passed and an acknowledgement (ACK) procedure and/or Automatic Retransmission Request (ARQ) is implemented. According to the invention, during a step 79, if a PDU transmitted by the BS is correctly received, then the station 3 transmits a positive acknowledgement ACK to the BS. According to the invention, during a step 79, if a PDU transmitted by the BS is correctly received, then the station 3 transmits a positive acknowledgement ACK to the BS. An ACK acknowledgement associated with a PDU identified by its number corresponds to a logical “OR” of the reception status of each PDU carrying the same identification number and transmitted by the BS. The acknowledgement feedbacks are sent to the BS by all the SS. According to the embodiment mode described here, the acknowledgement is selective. According to a variant, the acknowledgement is accumulative: Several acknowledgements corresponding to consecutive PDUs are accumulated; an acknowledgement corresponding to the last of the correctly received consecutive PDUs is transmitted to the BS. According to another variant, the acknowledgements are both accumulative and selective. The SS indicates the last correctly received PDU from a correctly received PDU sequence and the correctly received isolated PDUs after the last cumulative correctly received PDU. According to a variant, the test 78 and the step 79 are carried out in parallel with the step 41 (for example in a multitask environment).

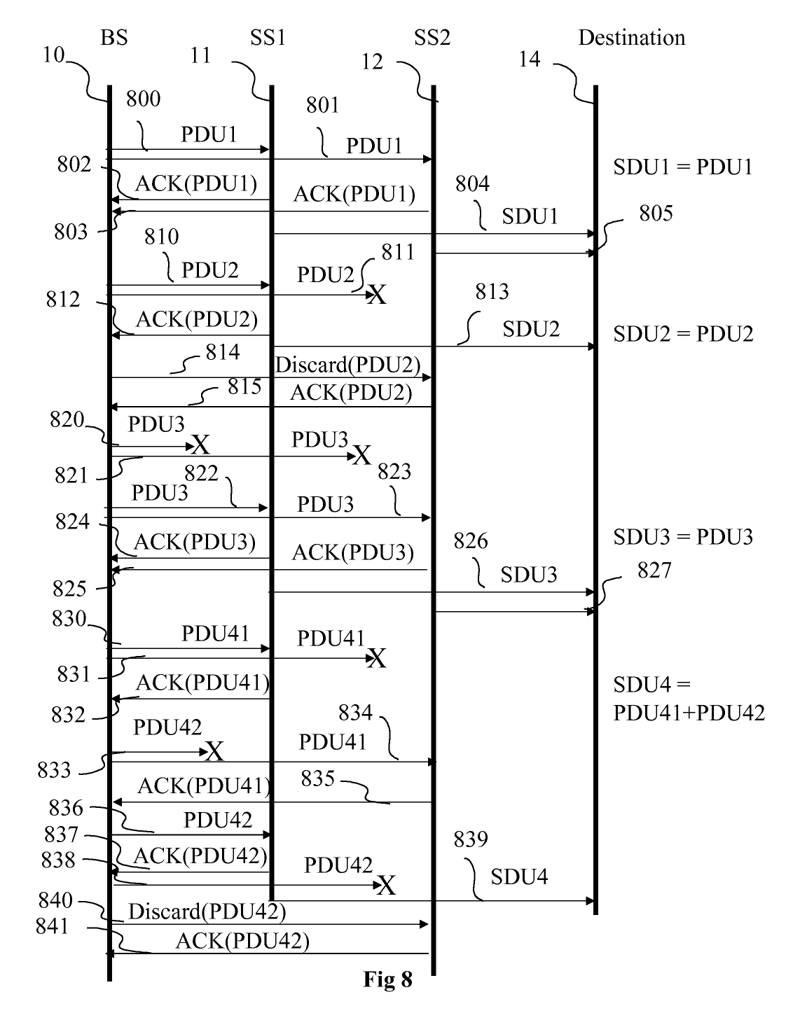

FIG. 8 illustrates an example of communication between the base station 10, the subscriber stations 11 and 12 and the destination 14 (these elements are represented by vertical lines; the actions, events and/or successive transmissions are chronologically illustrated). In order to facilitate the reading of the example, only two subscriber stations 11 and 12 are mentioned. The example can be extrapolated to any number of base stations and subscriber stations.

The BS 10 transmits signals 800 and 801 comprising a PDU to each of the subscriber stations 11 and 12. As an example, it is the same destination 14 node which receives or transmits the data coming from or destined for the base station 10. According to FIG. 8, the PDUs are transmitted to the subscriber stations in the form of separate frames with a recipient address corresponding to a unique SS (unicast). According to a variant, the signals 800 and 801 are advantageously combined into one single signal (signal broadcast to all the SS (multicast)). Likewise, according to the different embodiments, the PDUs are transmitted by the BS in the same connection to all the SSs or in the different connections.

Then, for the correctly received frames, the SSs 11 and 12 transmit the acknowledgements corresponding to the base station 10. In order to facilitate the reading of the diagram, it is assumed that the PDUs corresponding to the SDU 800 or 801 are transmitted in a single burst.

According to a first scenario, it is assumed that the PDUs 800 and 801 are correctly received by the SSs 11 and 12. They are therefore acknowledged by the SSs 11 and 12 which transmit a positive acknowledgement (802 and 803) to the BS. Each positive or negative acknowledgement transmitted comprises the CID and the number of the PDU or PDUs (with, if necessary, a selective or cumulative acknowledgement identification). Then, supposing that the SDU comprises only the acknowledged PDU or PDUs, the SSs 11 and 12 transmit the SDU (804, 805) to the recipient node.

According to a variant not shown, the SSs implement the acknowledgement exchanges between themselves.

According to a second scenario, the BS 10 transmits signals 810 and 811 comprising one or more PDUs forming a single SDU to each of the subscriber stations 11 and 12, only the signal 810 is correctly received by an SS. The SS 11 then transmits an acknowledgement to the BS 10 and the entire SDU 813 to the destination node. The BS 10 transmits to the SS 12 a message 814 of the discard type associated with the PDUs acknowledged by the SS1. The SS 12 acknowledges (815) the “discard” message.

According to a third scenario, the BS 10 transmits signals 820 and 821 comprising a PDU (PDU3=SDU3) to each of the subscriber stations 11 and 12. It is assumed that none of the signals 820 and 821 are correctly received by the SSs. The BS retransmits the non acknowledged PDUs in the form of signals 822 and 823 which it is assumed are correctly received. A scenario corresponding to the first scenario is thus obtained.

According to a fourth scenario, it is assumed that an SDU transmission split into PDU transmits in distinct bursts (PDU41 and PDU42) by the BS. The BS firstly transmits the bursts 830 and 831 respectively comprising a first set of one or more PDUs (PDU41) extracted from the SDU (SDU4) received from an application and to transmit to a destination node through SS, then the bursts 833 and 838 respectively comprising a second set of one or more PDUs (PDU32) extracted from the SDU (SDU4).

As an example, it is firstly assumed that only the burst 830 is received correctly by the station 11. It then transmits a positive acknowledgement for the first set of PDU (PDU41) in a burst 831.

Then, the BS transmits a burst 833 comprising the second set incorrectly received by the SS 11 and a burst 834 comprising the first set correctly received by the SS 12. The latter acknowledges the first set of packets (835).

Then, the BS transmits the bursts 836 and 838 comprising the second set. Only the SS 11 correctly receives the burst 836 that it acknowledges. It therefore constructs the SDU comprising the two sets and transmits it to the node 14 (839). As summary, the SS constructs a SDU from one or more PDU packets, if all corresponding PDU have been correctly received; then, it sends the constructed SDU packets to the destination. According to a variant, a SS receives PDU not correctly received directly from the BS, from another SS that has correctly received this PDU. Thus, the SS can construct the corresponding SDU without waiting a missing PDU from the BS (on the wireless link).

The BS 10 transmits to the SS 12 a message 840 of the discard type associated with the second set of PDUs acknowledged by the SS1. The SS 12 acknowledges (841) the “discard” message and updates the statuses of the corresponding PDUs.

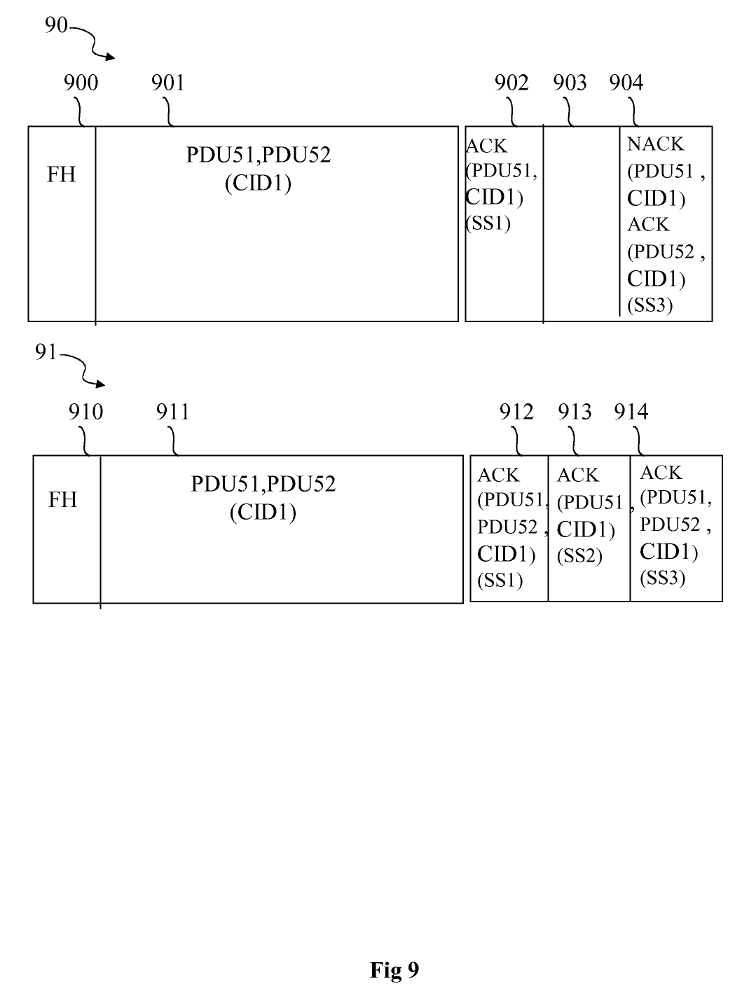

FIG. 9 chronologically illustrates the emission and the reception of successive frames 90 and 91. The frame 90 (91 respectively) is divided into two intervals corresponding respectively to the “downlink” direction, base station to SS and in the “uplink” direction, SS to base station.

The slot 90 comprises:
one part reserved for frame headers in the time slots assigned to each BS,
one part reserved for the transmission of data to the SS or SSs connected in the time slots assigned to each BS,
one part (not shown) enabling exchanges in contention mode (notably to enable the SS not associated or not connected to do it), and
one part reserved for the transmission of data to the BS from the SS connected, in the time slots assigned to each SS.

In the first part of the slot 90, the base station emits or receives firstly a frame header or FH 900. The attribution of slots for the FH is unremarkable (for example determined according to the declaration order in the network). When an SS is associated to a BS, the BS receiving the association demand allocates in a unequivocal manner the time resources for the transmission and/or the reception of data packets.

Then, the base station sends a frame 901 comprising two PDU sets (PDU51 and PDU52) to the SSs associated with a connection (CID1).

Then, each of the SS 11 and 13 successively transmits a burst 902 and 904 respectively containing respectively an ACK for a first set of PDUs (PDU51) and a NACK for a first set of PDUs associated with an ACK for a second set of PDUs (PDU52). The station 12 does not send anything, the reserved time slot is empty.

The following frame 91 also comprises a header 910 similar to the header 900 and a retransmission of the frame 901 in a time slot 911.

Then, the frame 91 comprises the acknowledgements 912 to 914 of the PDU or PDUs correctly received by the SSs.

Naturally, the invention is not limited to the embodiments previously described.

In particular, the architecture of the mobile stations and base stations can be different from those illustrated in FIGS. 2 and 3, in the respective function and/or form of the elements (the functions of the electronic elements can notably be grouped into a restricted number of components or, on the contrary, expanded into several components) and their layout.

The invention is not limited to an architecture as described with respect to FIG. 1 but involves any architecture implementing a wireless network with local (for example a few tens of metres) or remote (for example a few kilometres according notably to a standard IEEE 802.16) coverage with one or more SS, each SS being connected at any time to at least one BS. According to one variant, the link between the BSs and/or between the BSs and the destination and/or source node is a wireless link (local or remote link).

The invention can also be applied with different communication protocols to those previously described. Hence, the application and/or control data can be transmitted according to any protocol (for example with a contention access or in polling mode) on the wireless links. The communication channels between the SS and the BS can use the same frequency channels for the upward and downward directions (mode known as “half duplex”) or different frequency channels (mode known as “full duplex”). The network or the links connecting the source to the SSs can also be unremarkable and is not limited to an Ethernet network. This means, for example, a standardised or proprietary protocol, wired or wireless enabling the data transmission from the source to each of the SSs.

Moreover, the packets (SDU) transmitted by the BS to the subscriber stations are advantageously and not necessarily split into packets (PDU) of MAC level. In the examples given previously the boundaries between SDU and PDU coincide. According to the variants of the invention, they do not coincide. According to other variants, a PDU can correspond to one or more SDUs.

According to specific embodiments, the subscriber stations are advantageously unremarkable stations compatible with the IEEE 802.16 standard. According to the variants of the invention, they comprise one part linked to wireless exchanges compatible with the IEEE 802.16 standard and one dedicated part aiming to improve the quality of service (for example, one part allowing the acknowledgements exchanged between subscriber stations to be managed).

The architecture of the base station is also not limited to the examples previously described. In particular, according to different embodiments, the application part of the base station (for example, data processing unit (notably voice and/or images), a camera control unit, etc.) can be integrated in an item of equipment comprising the radio and communication management part on the wireless link with the subscriber stations, or, on the contrary, separated completely or partly from this item of equipment. According to a particular embodiment, the application part of the base station is in a device separated from the communication part with the SS by a wired or wireless link: for example, the BS receives a video flow transmitted on Ethernet (or on a different wired or wireless link, following a standard protocol or proprietor) to a digital recorder, a screen or a computer.

Likewise, the architecture of the subscriber stations is also not limited to the examples previously described. In particular, according to different embodiments, the data source (for example, data processing unit (notably voice and/or images), an application control unit associated with the base station or stations, etc.) can be integrated in an item of equipment comprising the radio and communication management part on the wireless link with the base stations, or, on the contrary, separated completely or partly from this item of equipment.

According to a variant of the invention, a same PDU is not transmitted to all the SSs but to a sub-set (for example, to one or more SSs of which there is a good quality link with the BS (typically the SSs whose PDUs are correctly received by the BS)).

According to an embodiment variant of the invention, an SS can be temporarily removed from the SS sub-set communicating with the BS (if, for example the wireless link is bad, the wired link being maintained) reintroduced subsequently (for example when the link becomes satisfactory) after a resynchronisation of the ARQ windows.

The invention can advantageously be combined with the invention covered by the French patent application FR0755233 filed on the 24 May 2007 by Thomson Licensing and entitled “Data packet reception method and corresponding transmission method” or by corresponding international patent application. In an architecture similar to the FIG. 1 network, the latter provides the transmission of data packets of PDU by at least two SSs (second stations) to the BS (first station). More precisely, SDU are received by the SSs. Each SS then slices the received SDU into PDUs. For a given SDU, the corresponding PDUs built by different SSs have a similar structure (especially the size of payload is the same), the same numbering and the same content (payload). PDU sent by several SSs may have or not the same SS source address. Each data packet corresponding to a given payload (PDU) is thus transmitted on several links between the SSs and the BS. The BS transmits an acknowledgement (in a unicast or multicast mode) to each SS indicating that it has correctly received this PDU packet coming from at least one SS. When a PDU packet has not been acknowledged by the BS, the SSs transmit it to the BS again. In particular, the BS and SS of FIG. 1 network can advantageously implement both a transmission as disclosed in FIG. 6 and a reception.

1. Transmission method of first data packets, the method being implemented in a first station, each first packet being transmitted by said first station intended for at least two second stations, said second stations belonging to a set comprising several second stations, wherein the method comprises:
a reception of at least one acknowledgement of each first packet received correctly by at least one second station, said acknowledgement or acknowledgements being transmitted by the second station or stations having correctly received said first packet to the first station,
a retransmission of each first packet not acknowledged at least once, each first packet acknowledged at least once not being retransmitted.

2. Method according to claim 1, wherein it comprises:
a split of a second data packet in one or more first data packets (PDU);
a retransmission of each first packet not acknowledged at least once belonging to a second packet of which at least one first packet has not been acknowledged at least once, the first packets not being retransmitted when they belong to a second packet of which all the first packets have been acknowledged at least once by at least one second station.

3. Method according to claim 2, wherein it comprises:
a retransmission of each first packet not acknowledged at least once belonging to a second packet of which at least one first packet has not been acknowledged at least once, the first packets not being retransmitted when they belong to a second packet of which all the first packets have been acknowledged at least once by at least a same second station.

4. Method according to claim 2, wherein it comprises a discard request of at least one first packet to a second station comprises when all the first packets of the second packet have been acknowledged at least once by at least one second station.

5. Method according to claim 4, wherein it comprises a discard request of at least one first packet to a second station when all the first packets of the second packet have been acknowledged at least once by at least one same second station.

6. Method according to claim 1, wherein said packet or packets are in the access control communication layer in the medium called MAC layer

7. Method according to claim 1, wherein said packet or packets are transmitted on a wireless channel.

8. Method according to claim 1, wherein said packet or packets are transmitted according to an IEEE 802.16 protocol.

9. Method according to claim 1, wherein it comprises the following steps:
reception of data packets by said first station, the data packets being built by said second stations from a given service data unit packet and having a similar structure and the same numbering; and
transmission of an acknowledgement to each second station indicating that the first station has correctly received at least a data packet from at least a second station.

10. Reception method of first data packets, the method being implemented in at least two second stations, each first packet being transmitted by said first station intended for said at least two second stations, wherein the method comprises:
a reception of at least a first data packets by at least one of said second stations;
a transmission of at least one acknowledgement of each first packet received correctly by at least one second station, said acknowledgement or acknowledgements being transmitted to said first station by the second station or stations having correctly received said first packet from the first station;
a construction of a second data packet from one or more first data packets, if all corresponding first data packets have been correctly received, and a sending of said second data packet to a destination; and
a discard of at least one first packet upon a reception of a corresponding discard request from the first station.
